(19) United States
(12) Patent Application Publication
(10) Pub. No.: US 2008/0131858 A1
(43) Pub. Date: Jun. 5, 2008

(54) METHOD AND APPARATUS FOR CREATING A CUSTOM BLENDED FRAGRANCE

(76) Inventor: McKenna Gordon, Pleasant Grove, UT (US)

Correspondence Address: MADSON & AUSTIN, 15 WEST SOUTH TEMPLE, SUITE 900, SALT LAKE CITY, UT, 84101, US

(21) Appl. No.: 11/565,504

(22) Filed: Nov. 30, 2006

(51) Int. Cl. G09B 3/00; B65D 69/00

(52) U.S. Cl. 434/327; 206/223

(57) ABSTRACT

A method for determining a unique scent for an individual is described. A personality test may be administered to an individual, and the results of the personality test may be evaluated. The results of the personality test may determine one or more characteristics of the individual's personality. One or more families of scents may also be provided to the individual. The families of scents may correspond to the characteristic of the individual's personality. Using the results of the personality test and the families of scents, an individualized scent for that person may be determined. Also, a kit is described herein that may be used to construct a unique, individualized scent for an individual. The kit may include a personality test that probes various characteristics of the individual's personality. One or more families of scents that correspond to the characteristic of the individual's personality may also be included in the kit.

### TECHNICAL FIELD

The present invention relates to perfumes and other health and beauty products. More specifically, the present invention relates to novel methods and apparatuses that may be used by a consumer to create a personalized, custom-blended fragrance that may be used with perfume, lotions, shampoos, other health and beauty products, air freshener or room spray, and other commonly scented products.

### BACKGROUND

Perfumes, lotions and other bath and body products are available at retail stores in many different scents. Consumers are limited to products with scents created by others and that can be worn by anyone. Perfumes are marketed and sold based on personalities or moods that one might want to portray for a specific occasion. However, no two people are alike in personality or mood, and just as no woman wants to be seen in the same dress as another woman at a social gathering, they also prefer not to wear the same fragrance as another woman. Although scents are a subtle sensory input for most people, they create a powerful stimulus to memories of people, places and situations. Men who smell a woman's scent that reminds them of a previous partner will consciously or subconsciously respond to the new acquaintance based on old memories remembered due to a common fragrance. No one wants to be associated to or interpreted like the old partner.

Consumers are always looking for something new and unique. People have long gone to great lengths to express themselves as individuals. Cars, clothing, accessories, perfume, etc. are marketed using images that portray personality types, yet the products can be purchased by anyone. A woman's scent is a very intimate portrayal of her attitude and personality. Most women want to be understood and accepted as individuals. A personalized scent is a subtle yet powerful way to express one's unique attributes.

There are literally millions of combinations of scents that can be created with perfume oils that are generally available. Understanding how to blend a fragrance that is suitable to any one individual requires a vast amount of knowledge, experience and training. This invention provides affordable materials and efficient methods to an individual/consumer in a home demonstration environment where they can blend a custom, personalized scent that is unique to them and that only they can wear.

### BRIEF DESCRIPTION OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a perspective view of a perfume kit according to the present embodiments;

FIG. 2 is a flow diagram of one embodiment of a method that an individual may use to determine a unique, individualized scent;

FIG. 3 is a flow diagram that illustrates one embodiment of a method for evaluating the results of a personality test; and

FIG. 4 is a flow diagram of one embodiment of a method for determining and constructing the unique, individualized scent using the results of the personality test;

FIG. 5 is a flow diagram that shows a second embodiment of a method that an individual may use to determine a unique, individualized scent;

FIG. 6 is a flow diagram that shows a second embodiment of a method that an individual may use to determine a unique, individualized scent;

FIG. 7 is an illustrative pie chart of one embodiment of an individual's personality profile;

FIG. 8 is an example of an “answer key” for a personality test that may be administered according to the present embodiments;

FIGS. 9a and 9b are examples of a list of scents that a user may use to modify her scent, as desired;

FIG. 10 is an example of a chart the links a particular emotion with one or more of scents or families of scents; and

FIG. 11 is a example of a chart that lists some “pre-blended” mixtures that a user may use in mixing her own distinct scent.

### DETAILED DESCRIPTION

The present embodiments include a method for determining a unique scent for an individual. This method may comprise the steps of administering a personality test and evaluating results of the personality test to determine one or more characteristics of the individual's personality. One or more families of scents that correspond to the characteristics of the individual's personality may also be provided. An individualized scent from the results of the personality test and the families of scents may then be determined.

In some embodiments of this method, the results of the personality test are evaluated at a workshop that helps the individual understand the test results. In further embodiments, the step of constructing a personality test that probes various characteristics of the individual's personality may be added to the method.

In other embodiments, the step of selecting scents from the families of scents will be added to the method. This selecting of scents may involve having the individual probe scents from the family(ies) of scents to determine which scents fit that person's olfactory and/or emotional preferences. In further embodiments, the families of scents is selected from the group consisting of floral, fruity, herby, leafy, spicy, and woodsy, and wherein an individual may select one or more scents from any of the families of scents.

The personality test may, in some embodiments, comprise a series of multiple-choice questions that are associated with each particular family of scents. In these embodiments, the multiple-choice personality test may be evaluated by assigning a numerical value to each possible answer for each multiple choice question and then determining the answer to each multiple choice question selected by the individual. Once the answer of the individual has been determined, the numerical value associated with this selected answers is verified. Finally, all of the numerical values associated with the selected answers are then summed up. Further embodiments, may involve the step of dividing the summed value of the numerical values associated with the selected answers by a grand total.

Different embodiments of the present method may also involve the step selecting scents from the families of scents, constructing an individualized scent from the selected scents, a; and then mixing the individualized scent with a health and beauty product. Other embodiments may further be constructed in which a chart or other reference guide is provided to the individual which links a particular emotion to a scent or family of scents. Additional embodiments may be designed in which a formula necessary to duplicate the individualized scent is determined.

A different embodiment for a method for determining a unique scent for an individual. This embodiment may involve administering a personality test and evaluating results of the personality test to determine one or more characteristics of the individual's personality. One or more families of scents that correspond to the characteristic of the individual's personality may also be provided. In these embodiments, a particular feeling that the individual desires may be determined, and then, once this feeling is ascertained, the family of scents associated with the particular feeling may also be determined. To determine which family of scents is associated with the particular feeling with a scent, a chart may be provided. Finally, the individualized scent from the results of the personality test, the particular feeling desired by the individual, and the families of scents may then be determined.

Further embodiments of a method for determining a unique scent for an individual may involve conducting a workshop with at least one individual and a scent consultant. One of more families of scents will then be provided. The families of scents each comprise a plurality of scents. Scents may then be selected that fit with the individual's preferences, wherein the scents are selected at the workshop with suggestions from the scent consultant This may occur by having the individual probe scents from the families of scents. Once selected, the scents may be mixed to form a scent that is unique to the individual. Further embodiments may involve the step of mixing the individualized scent with a health and beauty product.

Additional embodiments may further be designed in which a personality test is administered. The results of this personality test will also be evaluated. Such evaluation occurs at the workshop. The results of the personality test are evaluated to determine one or more characteristics of the individual's personality, wherein the results of the personality test are used to select the scents.

The present embodiments may also include a kit for preparing a unique scent for an individual. The kit may include a personality test that probes various characteristics of an individual's personality and one or more families of scents. The families of scents may correspond to a characteristic of the individual's personality. A health and beauty product may also be added to the kit, wherein an individualized scent from results of the personality test and the families of scents may be mixed with the health and beauty product. IN some embodiments, the health and beauty product is selected from the group consisting of lotions, perfumes, and shower products.

Further embodiments of the kit may be constructed in which the families of scents consisting of floral, fruity, herby, leafy, spicy, and woodsy. A chart which links a particular emotion to a scent or family of scents may also be included as part of the kit. In other embodiments of the kit, the personality test comprises a series of multiple-choice questions that are associated with each particular family of scents, wherein the kit further comprises an answer key that assigns a numerical value to each possible answer for each multiple choice question.

Various embodiments of the invention are now described with reference to the Figures, where like reference numbers indicate identical or functionally similar elements. The embodiments of the present invention, as generally described and illustrated in the Figures herein, could be arranged and designed in a wide variety of different configurations. Thus, the following more detailed description of several exemplary embodiments of the present invention, as represented in the Figures, is not intended to limit the scope of the invention, as claimed, but is merely representative of the embodiments of the invention.

The word “exemplary” is used exclusively herein to mean “serving as an example, instance, or illustration.” Any embodiment described herein as “exemplary” is not necessarily to be construed as preferred or advantageous over other embodiments.

As used herein, the terms “an embodiment,” “embodiment,” “embodiments,” “the embodiment,” “the embodiments,” “one or more embodiments,” “some embodiments,” “certain embodiments,” “one embodiment,” “another embodiment” and the like mean “one or more (but not necessarily all) embodiments of the disclosed invention(s),” unless expressly specified otherwise.

The term “determining” (and grammatical variants thereof) is used in an extremely broad sense. The term “determining” encompasses a wide variety of actions and therefore “determining” can include calculating, computing, processing, deriving, investigating, looking up (e.g., looking up in a table, a chart or another data structure), ascertaining and the like. Also, “determining” can include receiving (e.g., receiving information), accessing (e.g., accessing data) and the like. Also, “determining” can include resolving, selecting, choosing, creating, establishing, and the like.

The term “health and beauty product”, or “bath and beauty product” is used as a general description of products most commonly scented for personal use. These terms are used to also include any product that is scented or product that an individual may wish to scent with their unique, individualized scent. These products may include, for example, air fresheners, or other commonly scented products.

The phrase “based on” does not mean “based only on,” unless expressly specified otherwise. In other words, the phrase “based on” describes both “based only on” and “based at least on.”

The term “woman” or “her” is non-gender specific and is used to accommodate simplified English expression. In other words, the phrase “to mix her unique scent” does not identify “her” as exclusively female, but refers to an individual of either gender.

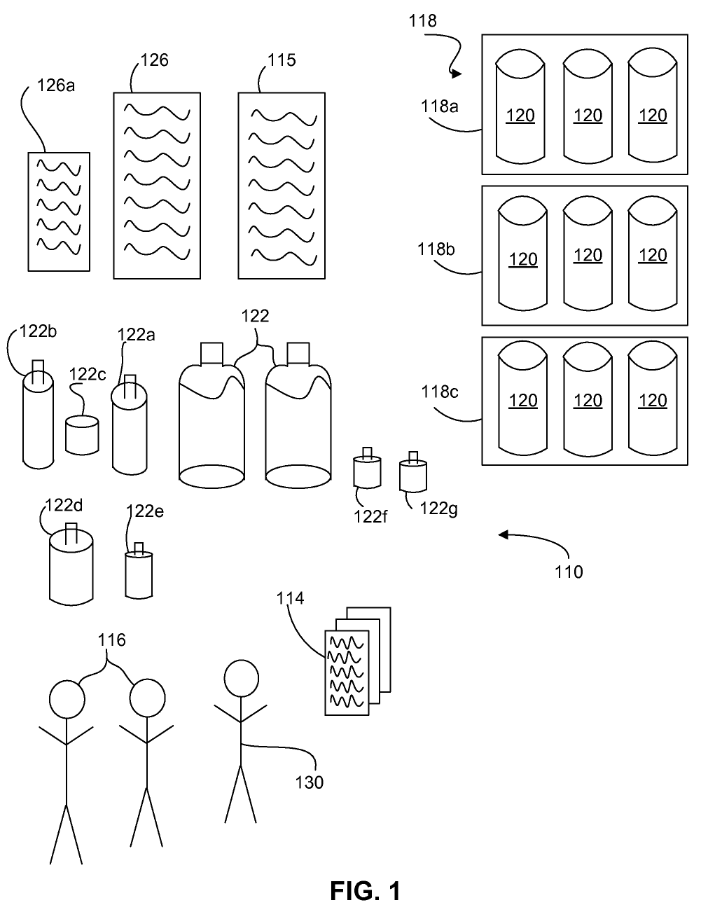

Referring now to FIG. 1, a kit 110 according to the present embodiments is illustrated. The kit 110 is designed such that it may be used by an individual 116 (such as a woman) to create a unique, individualized scent. As will be explained in greater detail herein, this individualized scent may be used directly in a perfume base product or may be used to scent another health and beauty product (such as soap, lotion, shampoo, shower products, body wash, facial creme, air freshener or other commonly scented product, etc.). The kit 110 also allows the individual 116 to create a unique scent that may be used for a wedding, a date, a social gathering, etc. This individualized scent also allows a woman to mix/create a specialized scent that conveys a specific mood, a specific feeling, etc.

The embodiment of the kit 110 is only one example of the type of kit that may be used. Other embodiments may be constructed in which additional elements or components of the kit 110 are also used. The kit 110 of FIG. 1 is designed such that it is portable. Accordingly, an individual may take the kit 110 to different settings and use it on different occasions to help different women construct their own personalized scent(s). For example, an individual may hold a “party,” workshop, or other social gathering in which she invites her friends. At this party, a representative 130 may have the kit 110 and may use the kit 110 to help each attendee at the workshop construct their own unique scent. This representative 130 is sometimes referred to as a “Fragrance Designer” or “Scent Consultant”. (The exact role and function of the representative 130 is described in greater detail herein).

As shown in FIG. 1, the kit 110 may include a personality test 114 that may be administered to various individuals 116. The personality test 114 may be printed out in paper form or may be available (either exclusively or non-exclusively) online (or in another type of electronic format). Multiple copies of the personality test 114 may also be included in the kit 110 so that if the kit 110 is taken to a workshop or social gathering, each person attending the event can take her own personality test. The personality test 114 is designed to probe one or more characteristics of the individual's personality. One example of a personality test that may be used as part of the kit 110 is given herein.

As each individual 116 has a different and unique personality, each person taking the personality test will likely have different results than other individuals. These individualized results of the personality test 114 may then be used and analyzed to help each individual 116 create their own unique scent (as is explained in detail herein).

An “answer key” 115 may also be provided as part of the kit 110. The answer key 115 is associated with the personality test 114. As with all types of personality tests, there are no “correct” answers to the questions on the personality test 114. Rather, each question is designed to categorize the individual's personality. The answer key 115 does not provide a list of “correct” answers. Instead, the answer key 115 provides a means for “scoring” or “evaluating” the individual's answers to the questions asked in the personality test 114. From these answers provided, various characteristics or aspects of the individual's personality may be ascertained. One example of an answer key 115 is provided herein.

For example, embodiments may be constructed in which the personality test 114 comprises a series of multiple choice questions and the answer key is simply a list that provides a numerical value for each answer that was selected by the individual 116. Thus, by adding up the numerical value associated with each selected answer, the personality test 114 may be quickly scored and evaluated.

In the embodiments in which the personality test 114 is administered in an electronic format, the answer key 115 may be provided as part of the internal workings/functionality of the electronic test. For example, if the personality test 114 is administered online, the answer key 115 may be an inherent part of the website such that after the individual 116 finishes the test 114, her answers are already evaluated and scored based upon the answer key 115 programmed into the website or computer.

The kit 110 will also include at least one family 118 of scents. Each scent as included in kit 120 may be a single note scent or a blend of scents. As shown in FIG. 1, three families 118a, 118b, 118c of scents are illustrated. More or less than three families of scents may also be used. The families 118a, 118b, 118c of scents may be groupings of fragrances that all have a scent from a similar source or portray similar personality attributes. For example, one family of scents may be a “floral” family in which one or more of the scents have an aroma of flowers. Another family of scents may be a “spicy” family in which one or more of the scents have aromas associated with cooking spices. Another family of scents may be a “fruity” family in which one or more of the scents have aromas associated with fruits/vegetables. A “woodsy” family (in which one or more the scents relate to the woods/outdoors or animal scents) is also possible. A “leafy” family in which one or more of the scents relate to plants are also possible. An “herby” family in which one or more of the scents relate to herbs are also possible. Individual scents may be grouped into families based on both the above associations as well as the personalities that the scent portrays. For instance, “Lemon,” although otherwise is commonly considered a fruit, for purpose of personality scent associations may be in the floral family, as Lemon more accurately portrays the personality traits of the floral family. Still other families of scents may be constructed.

In general, each family 118a, 118b, 118c may include perfume oils 120 for each particular scent. These oils 120 are generally concentrated and are designed such that they will be mixed with other products or diluted. Those of skill in the art will know and understand how/where these oils 120 can be obtained and/or purchased. For example, a “perfume” that is made from the scents will generally comprise a plurality of drops of the scents 120 that is mixed with other “filler” material(s) (as is known in the art) in order to produce the perfume. Accordingly, just a few drops of the oils 120 will be used for each particular product.

In order to facilitate the mixture of the oils 120 with other products, one or more droppers (not shown), pipettes, or other transferring devices may be included as part of the kit 110. Still further embodiments may be designed in which each container that houses one of the oils 120 has its own individualized dropper. One or more mixing glasses (that are designed to facilitate the mixing of drops of the oils 120) and/or one or more stirrers, mixing sticks, or other similar devices, may also be added to the kit 120.

Although the kit 110 shown in FIG. 1 comprises nine different perfume oils 120, many more different perfume oils and scents may be used as part of the kit 110. For example, embodiments of the kit 110 may be made in which sixty-five (65) different oils 120 are used. These sixty-five oils are broken up into six (6) specific families of scents, namely the “Floral” family, the “Fruity” family, the “Herby” family, the “Leafy” family, the “Spicy” family, and the “Woodsy” family. Other or additional and different families and/or additional and different oils 120 are also possible.

As is explained in greater detail herein, the kit 110 may be designed such that by using the results of the personality test 114, an individual can construct their own individualized scent/fragrance from the various families 118 of scents. This individualized scent may then be mixed with one or more health and beauty products 122. The health and beauty products 122 are generally unscented products. Those of skill in the art will know how/where to obtain or purchase unscented health and beauty products. Accordingly, when the scent is added, these products will have each person's own individualized scent. In some embodiments, the products 122 will be soap 122a, lotion 122b, perfume 122c, shampoo 122d, body wash 122e, facial creme 122f, shower gel 122g, etc.

A chart 126 or other similar type of reference guide 126a may optionally be included as part of the kit 110. The chart 126 links a particular emotion, feeling to a scent 120 or to a family 118 of scents. An example of one embodiment of the chart 126 is provided herein. Thus, if the individual 116 wants to convey a specific feeling or emotion (such as “energetic”), then individual can look this feeling up on the chart 126 and know what scent 120 or family(ies) 118 of scents would be useful in constructing the individualized scent.

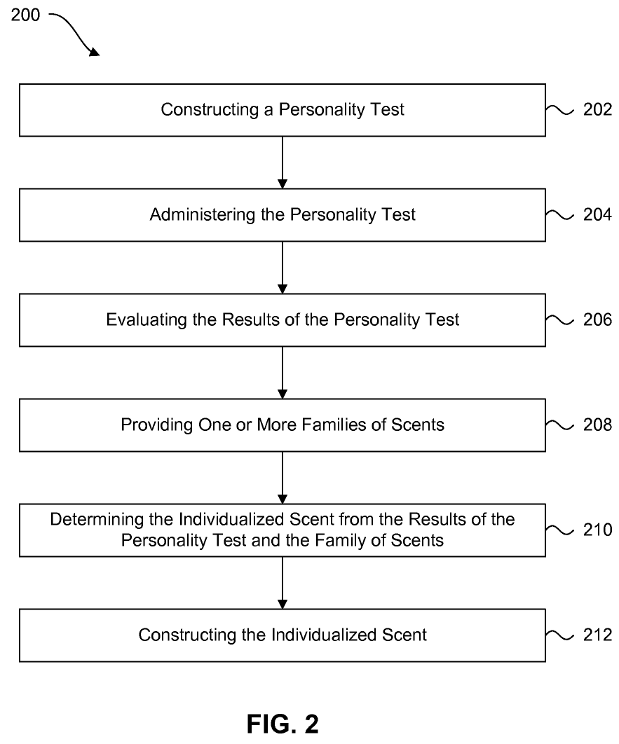

The kit 110 may be used by an individual to determine and construct an individualized, unique scent. This unique scent may be one that is personal to the use and is liked by the user. As is explained herein, the individual may be involved in selecting the fragrance that is particularly well-liked by her and/or may be tailored to her personality, emotional state, etc. One embodiment of a method 200 that an individual may use to determine this unique, individualized scent is found in the flow chart found in FIG. 2.

The method 202 may include the step 202 of constructing a personality test that is designed to probe one or more characteristics of an individual's personality. In some embodiments, this constructed personality test will have various sections and wherein each section relates to a specific family of scents. It should be noted that the step 202 of constructing a personality test is optional. Embodiments may be constructed in which the method 200 will involve obtaining or using a personality test that has previously been constructed.

The next step in the method 200 involves administering 204 the personality test to one or more individuals. As noted above, the personality test may be administered at a party or other social gathering in which each member of a group takes a different copy of the personality test. In other embodiments, the personality test may be administered individually. In yet further embodiments, the personality test may be administered online (or electronically) and the individual takes the personality test on her own time.

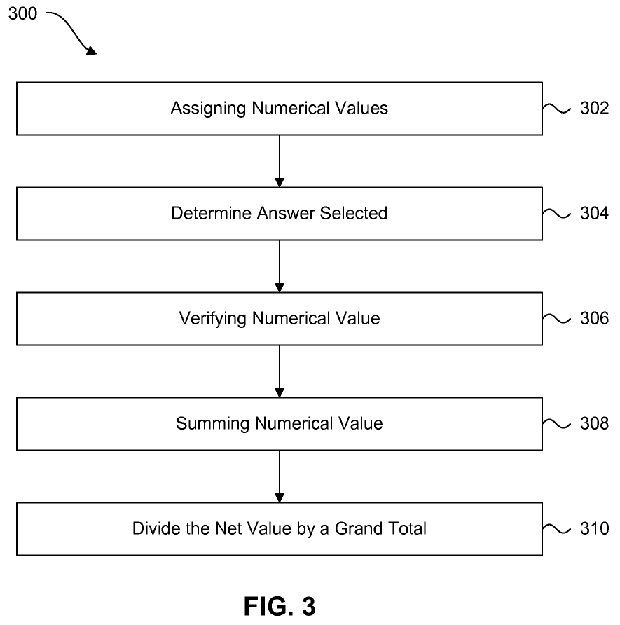

Once the personality test has been administered, the results of the personality test will be evaluated (as part of step 206). In general, this evaluating 206 of the results of the personality test operates to determine one or more characteristics of the individual's personality. Such evaluating of the results occurs usually by scoring the personality test. One embodiment of the way in which the results of the personality test may be evaluated are described herein (including the method of FIG. 3).

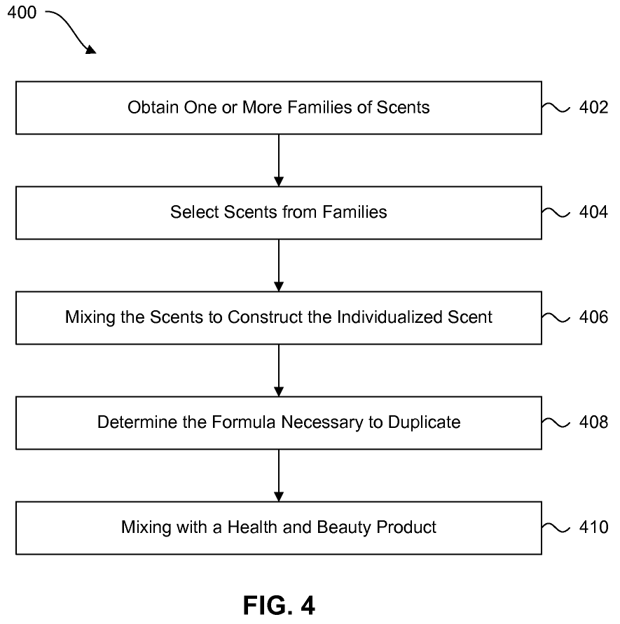

Once the results have been evaluated, thereby revealing one or more of the characteristics of the individual's personality, one or more families of scents will then be provided 208. The user may then take the results of the personality test and the one or more family of scents to determine 210 her individualized, unique scent. An embodiment of the way in which an individual may determine the individualized, unique scent is illustrated and described in conjunction to FIG. 4.

Once the individualized scent has been determined 210, this scent may then be constructed 212. In general, this scent will be constructed by mixing various oils and/or other fragrances together to create a unique scent. This individualized scent may then be mixed with perfume, health and beauty products, etc.

Referring now to FIG. 3, a flow diagram illustrates a method 300 that may be used to evaluate the results of a personality test taken by an individual. In this embodiment, the personality test is a multiple-choice test that is divided into one or more sections. Each of the sections on the multiple choice test corresponds to a different family of scents. Accordingly, the answers provided by the individual for each section determine whether this family of scents is “dominant,” whether this family of scents is likely to be preferred, or whether this family of scents is characteristic of the individual.

In the method 300, each of the questions of the personality test are multiple choice and each answer for the multiple choice test is assigned 302 a specific numerical value. For example, if there are three (3) possible answers to a particular multiple choice test, then the first answer choice may be assigned a numerical value of “3”, the second answer choice may be assigned a value of “1” and the third answer choice may be assigned a value of “−1”. If more than three answers are possible for a particular questions, these additional answers may also be assigned numerical values.

Once each of the potential answers on the multiple-choice test is assigned a particular numerical value, the particular answer selected by the individual taking the test is then determined 304. Generally, this occurs very quickly and easily and involves simply examining the paper to determine which answer choice was circled (or otherwise selected).

Once it is determined which answer choices were selected by the individual, the assigned numerical value associated with each selected answer choice is verified 306. This step generally involves looking at the answer key to find the assigned numerical value. For example, if the person selected answer choice “a”, then this step involves verifying which numerical value is associated with selected answer choice “a”.

Once the numerical values associated with the selected answer choices have been verified, the numerical results of this section will then be summed 308 (added together) to obtain a net value. This net value is the value that is associated with a particular section of the personality test and may be used to determine whether the individual demonstrates an affinity to a particular family of scents. The following table (Table 1) gives an example of the answers which an individual may select from the questions of a personality test associated with a “Fruity” family of scents, as well as the corresponding numerical values:

TABLE 1

| | | Assigned Numerical Value |
|---|---|---|
| | Answer Choice | Associated With Selected |
| Question in the | Selected by | Answer that is verified from the |
| “Fruity” family | individual | answer key |
| 1 | “a” | 3 |
| 2 | “a” | 3 |
| 3 | “c” | −1 |
| 4 | “b” | 1 |
| 5 | “c” | −1 |
| 6 | “a” | 3 |
| | Net Value | 8 |
| | (Sum of the numerical | |
| | values) 1 | |

Thus, in the above-recited table (Table 1), the summed “net” value associated with the “Fruity” family would be “8” for this particular individual. As will be explained herein, this value of “8” may then be used and manipulated to determine an appropriate individualized scent for this individual.

In further embodiments, an additional step of dividing 310 the net value by a grand total may also be performed. This grand total represents the summation of all of the particular net values associated with all of the sections of the test. For example, if the personality test had three (3) distinct sections, a “Fruity” section, a “Floral” section, and a “Woodsy” section, and each of the net values associated with these sections were “8”, “4”, and “6” (respectively), then the grand total for this individual would be “18” (because 8+4+6=18).

The dividing step 310 provides a percentage listing that may determine whether the individual will demonstrate an affinity to a particular family of scents. The dividing step 310 involves dividing each particular net valued by the grand total. Using the numbers associated with the previous example, the dividing step 310 would occur as follows:

| | Net Value Associated | | Percentage Associated |
|---|---|---|---|
| Family of | With a Particular | | With This Family Of |
| Scent | Family | Grant Total | Scents |
| Fruity | 8 | 18 | 44.44% |
| | | | (which is equal to 8 |
| | | | divided by 18) |
| Floral | 4 | 18 | 22.22% |
| | | | (which is equal to 4 |
| | | | divided by 18) |
| Woodsy | 6 | 18 | 33.33% |
| | | | (which is equal to 6 |
| | | | divided by 18) |

Based upon the above-recited percentages, it can be stated that the individual's personality is about 44% Fruity, about 33% Woodsy, and about 22% Floral. Accordingly, using these percentages, it is known that the dominant families of scents associated with this individual are likely to come from the Fruity or the Woodsy family of scents. Such information may then be used and manipulated to construct and determine a unique scent for a particular individual.

FIG. 4 illustrates one embodiment of a method 400 that uses the results of the personality test, in conjunction with one or more families of scents, to determine an individualized scent. Specifically, once the results of the personality test have been evaluated (either in the manner outlined in FIG. 3 or in some other manner), the individualized scent may then be determined.

The first step of the method 400 for determining the individualized scent involves obtaining 402 one or more families of scents. These families of scents may be obtained from the kit 110 (of FIG. 1) or otherwise. In some embodiments, each family of scents may correspond to a particular section of the personality test taken by the individual.

Once the family(ies) of scents have been obtained 402, the individual may then select 404 scents from the various families that appeal to her tastes. In some embodiments, such selecting 404 may occur by having the individual smell or probe each of the scents (such as the oils 120 of FIG. 1) in a particular family to determine which, if any, of these scents are appealing. Obviously, the individual may not like all of the scents associated with a particular family of scent. However, it is likely that at least one or two of the scents in this family will appeal to the olfactory and/or emotional preferences of the individual. Usually, it is wise to have the individual start probing the family of scents that had the highest percentage. Thus, in the example above, the “Fruity” family had the highest percentage (44.4%), and thus, the individual will start by smelling/determining which of these “fruity” scents are most desirable.

Once the individual has finished selecting the scents from the “Fruity” family, the individual may, if desired, select various scents from the other families (such as the “Woodsy” family or the “Floral” family, or any other relevant family). In this manner, the individual will find various scents from all of the relevant families that she may wish to use/try in the future.

Once the individual has selected the various scents, the individual will then proceed to the mixing step 406. In the mixing step, the individual takes the various scents that she selected previously and begins mixing them together. This mixing step 406 can involve “trial and error” as the individual determines which combinations of scents and the amount of each scent that is preferred. If the individual mixes various oils and scents and does not like the resulting scent or if she desires further modifications to the scent, the individual is free to start over, continue modify the mixture, add new scents/oils, etc.

Once the individual has achieved one or more desired scents (via the trial and error process), the individual will have a personalized, individualized scent that is unique to their personality. Accordingly, in some embodiments, this will end the method 400. However, in other embodiments, one or more additional steps may also be provided. Such steps may include determining 408 the formula necessary to duplicate or scale the desired scent. Such duplication or scaling of the scent may be necessary if the individual desires to mix the scent with health and beauty products. One embodiment of the way in which such duplication/scaling of the individualized scent may occur is disclosed below. Still further embodiments may include the additional step of mixing 410 the desired scent with one or more health and beauty products.

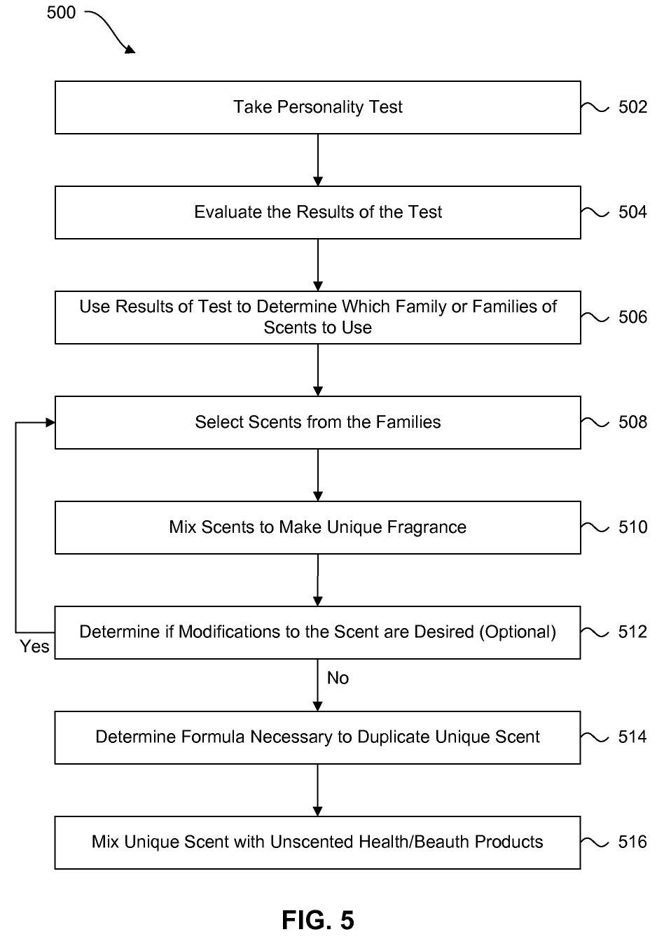

Although there are a variety of different ways and mechanisms to implement the present embodiments, a specific example will now be provided of one apparatus and method for determining and constructing an individualized scent. The steps of this method 500 of determining an individualized scent are shown in FIG. 5 and are described in greater detail below.

In the embodiment of FIG. 5, there are six different families of scents: “floral”, “fruity”, “herby”, “woodsy”, “spicy”, and “leafy”. Of course, other embodiments may have more or less than six families of scents, as desired. The following table (Table 2) shows the various scents that are (or may be) associated with each of these particular families of scents. This listing of scents is, of course, non-limiting. Variations to this list are within the scope of the present embodiments. For example, additional scents not listed may also be used, whereas in other embodiments, fewer than all of the scents listed below will be used.

TABLE 2

| Floral | Fruity | Herby | Leafy | Spicy | Woodsy |
|---|---|---|---|---|---|
| Asian | Apple | Almond | Aloe Vera | Absinthe | African |
| Bloom | (McIntosh) | | | | Musk |
| Jasmine | Apricot | Awapuhi | White Tea | All Spice | Bay Rum |
| | | (Hawaiian | | | |
| | | white | | | |
| | | ginger) | | | |
| Cactus | Banana | Basil | Blue Grass | Amaretto | Brown |
| flower | | | | | Sugar |
| Calalily | Blackberry | Bergamot | Eucalyptus | Amber | Butterscotch |
| Carnation | Black | Sage | Fern | Anise | Caramel |
| | Cherry | | | | |
| Chamomile | Black | Garden Mint | Grass | Bayberry | Cedarwood |
| | Coconut | | | | |
| China lily | Blueberry | Ginger | Green Tea | Coffee | Chestnut |
| Desert Rose | Naked | Ginger Ale | Hawaiian | Champa | China Musk |
| | | | Rain | | |
| Freesia | Cantaloupe | Lavender | Heliotrope | Chocolate | Chypre |
| Gardenia | Cherry | Patchouli | Honeysuckle | Cinnamon | Cypress |
| Geranium | Cranberry | Peppermint | Ivy | Clove | Dogwood |
| | | | | | Blossom |
| Ginger lily | Cucumber | Rosemary | Maile Leaf | Dragon's Blood | Egyptian |
| | | | | | Musk |
| Hibiscus | Dulce de | Spearmint | Sweetgrass | Frankincense | Evergreen |
| | Leche | | | | |
| Hydrangea | Fig | Wintergreen | Tomato Leaf | Hazlenut | Pine |
| Iris | Frangipani | Ylang Ylang | Verbena | Hollyberry | Musk |
| Juniper | Vanilla | | | Leather | Myrrh |
| Lemon | Grape | | | Nag Champa | Oakmoss |
| Lilac | Grapefruit | | | Nutmeg | Sandalwood |
| Lily | Green Apple | | | Spiced Chai | Spikenard |
| Linden | Guava Fruit | | | | Vetiver |
| blossom | | | | | |
| Lotus flower | Honey | | | | White Musk |
| Magnolia | Honeydew | | | | |
| Mimosa | Jamaican | | | | |
| | Fruit | | | | |
| Mulberry | Kiwi | | | | |
| Orange | Lime | | | | |
| Orchid | Mandarin | | | | |
| Osmanthus | Mango | | | | |
| Pansy | Muscadine | | | | |
| | (white | | | | |
| | grape) | | | | |
| Passion | Papaya | | | | |
| Flower | | | | | |
| Peony | Passion Fruit | | | | |
| Pikake | Peach | | | | |
| Flower | Blossom | | | | |
| Plumeria | Pear | | | | |
| Tuberose | Pina Colada | | | | |
| Tulip | Pink | | | | |
| | Grapefruit | | | | |
| Violet | Pomegranate | | | | |
| Water lily | Pumpkin | | | | |
| Water lotus | Raspberry | | | | |
| Wisteria | Rose | | | | |
| | Starfruit | | | | |
| | Strawberry | | | | |
| | Rhubarb | | | | |
| | Tangerine | | | | |
| | Watermelon | | | | |
| | Yellow Silk | | | | |
| | Yuzu | | | | |
| | (Japanese | | | | |
| | grapefruit) | | | | |

The first step in the method 500 involves having the individual take 502 the personality test. As there are six different families of scents, there are six distinct sections of the personality test. The personality-test is designed in “multiple-choice” format so all the individual must do is select the answer choice that best answers the question and/or is most applicable to her life/personality/situation. Each question may have 3-4 possible answers, and each answer may be assigned a point value. Each section may contain 7 questions. Each section represents a fragrance family and tests the individual's resemblance to the fragrance family. There are a variety of different questions that may be used as part of the personality test. A few examples of the types of questions are given below. However, these examples are not limiting; other types of questions for the personality test are also possible.

The first section of the personality test relates to the “floral” family. The questions probe whether the individual is likely to appreciate floral scents, based upon her personality. The questions relating to this family of scents may include:

### 1. Do you make the best of yourself physically

a. I spend a while getting ready in the morning & check the mirror several times a day.
b. It's important I look clean and presentable at all times, but I don't go to any extremes.
c. It's all about comfort, not fashion.

### 2. I can pick up on the most subtle mood changes in people around me.

a. Strongly agree
b. Agree
c. Disagree
d. Strongly disagree
   3. I use flirting to get:
a. Romantic attention
b. I don't flirt
c. Dates, discounts, out of traffic tickets, backstage passes, my way.
   4. I strive for perfection in all aspects of my life: physically, socially, intellectually
a. Strongly agree
b. Agree
c. Disagree
d. Strongly disagree

### 5. What do you daydream about?

a. Social events, my dream home, romance, fashion, being famous.
b. Organizing my house, planning my week, how to spend my tax return.
c. I don't really daydream.

### 6. Guilt Is:

a. My constant companion, unfortunately.
b. My constant companion, fortunately.
c. Healthy in small dosages, but I'm good at letting go and starting anew.
d. Not healthy

### 7. When making a clothing purchase, which is most important to you?

a. Designer labels
b. Quality
c. Getting a great deal on price
d. Fashion appeal

The second section of the test personality test relates to the “fruity” family and probes whether the individual is likely to appreciate fruity scents, based upon her personality. Some of the questions related to this family of scents may include:

### 1. Are you a good employee?

a. Hard working, committed, responsible—I'm the ultimate employee.
b. I'm a better than average employee.
c. I'm alright
d. I wouldn't hire myself.
   2. My office/personal area looks like:
a. A tornado just passed over it: I can't find a thing
b. A tornado just passed over it: How else would I find anything?
c. Mostly clean except one or two project areas.
d. Organized & efficient: everything's stored away in the proper bin (with labels, of course).

### 3. I'm generally more positive than people around me.

a. Strongly agree
b. Agree
c. Disagree
d. Strongly disagree

### 4. In relationships, I'm typically the one most willing to work things out, even if it means complying.

a. Strongly agree
b. Agree
c. Disagree
d. Strongly disagree

### 5. If my trust is broken, I:

a. Will never trust that person again.
b. Forgive and forget, they couldn't have meant it.
c. Am devastated and feel depressed, unlike my usual self
d. Feel bad at first, but move on soon after.

### 6. How do you feel about rules?

a. They're needed to keep things running smoothly.
b. I'm generally conventional, but have a rebellious streak; I'll go against authority if it misbehaves.
c. Some rules are for our safety, but most are lame.
d. I break rules just for the sake of breaking rules.

### 7. I am emotionally secure

a. Strongly agree
b. Agree
c. Disagree
d. Strongly disagree

The third section of the test personality test relates to the “herby” family and probes whether the individual is likely to appreciate herby scents, based upon her personality. Some of the questions related to this family of scents may include:

### 1. The very highest satisfaction I can get out of life is from doing things for other people.

a. Strongly agree
b. Agree
c. Disagree
d. Strongly disagree

### 2. Are you a home-body?

a. I'm happiest when friends visit me at home.
b. I like being at home, but also enjoy being out of the house for work & play.
c. How boring. Where's the party?

### 3. Are you a worrier?

a. No. Life is too short to worry!
b. I think I'm an average worrier.
c. Everyone around me says I worry too much (I disagree.)
d. make it an art form.

### 4. Do you ask too many questions?

a. I really don't feel the need to pry into others' personal lives.
b. No, people appreciate questions about their lives. It makes them feel cared about.
c. I love to hear about others, but only if they offer the information.
   5. Regarding gossip:
a. I don't want to hear about it, let alone pass it along.
b. I won't repeat it, but love to hear it!
c. Good gossip only: I love to hear about what old friends are up to.
d. Give me all the gory details!

### 6. Do you have a care-taking personality?

a. I take care of everyone in my life: family, friends, co-workers, neighbors, etc.
b. I take care of my family.
c. I can barely take care of myself!

### 7. I am neighborly

a. Strongly agree
b. Agree
c. Disagree
d. Strongly disagree

The fourth section of the test personality test relates to the “leafy” family and probes whether the individual is likely to appreciate leafy scents, based upon her personality. Some of the questions related to this family of scents may include:

### 1. If I come across something I haven't heard of or don't understand

a. It drives me nuts. I'll spend hours in the library trying to figure out every detail.
b. I'll read an article or ask someone about it to get the general idea. Beyond that, I don't care.
c. I know that feeling all to well. Oh well!

### 2. Are you a theorist?

a. I'm attracted to abstract ideas, but generally don't come up with my own theories.
b. I usually have several original theories kicking around at the same time and enjoy discussing them with other intellectuals.
c. I'm open to abstract ideas, but usually end up thinking they're a little weird.

### 3. I am profoundly creative

a. Strongly agree
b. Agree
c. Disagree
d. Strongly disagree

### 4. If someone I know starts shouting or being rude to me, I:

a. Shrug it off. It's their problem anyway.
b. Wonder what I did wrong.
c. Wince as if receiving actual blows to the head.

### 5. Sometimes I spend so much time thinking, I forget to experience life.

a. Strongly agree
b. Agree
c. Disagree
d. Strongly disagree

### 6. When I'm really down, I:

a. Take a bubble bath or other indulgence
b. Go shopping
c. Call a friend to help buoy me up
d. Retreat into solitude and unplug the phone
   7. I don't do anything half-way. I'm an extremist.
a. Strongly agree
b. Agree
c. Disagree
d. Strongly disagree

The fifth section of the test personality test relates to the “spicy” family and probes whether the individual is likely to appreciate spicy scents, based upon her personality. Some of the questions related to this family of scents may include:

### 1. Are you an entrepreneur?

a. I'm a go-getter but can't seem to hold myself accountable for my own deadlines.
b. I prefer a 9-5er: more time for my personal life.
c. Not yet, but I'm the entrepreneurial type.
d. Through and through.

### 2. People tell me I have over-the-top reactions to everything . . . that I'm melodramatic.

a. Strongly agree
b. Agree
c. Disagree
d. Strongly disagree

### 3. How much do you talk?

a. When I have something to say, I'll pipe in, but usually I'm more of a listener.
b. I'm talkative.
c. Don't even try to get a word in edge-wise. I have story to tell.

### 4. Is money important?

a. Yes. Money is power.
b. From a spending point of view: Shop till I drop!
c. I'm happy as long as the basic needs are met.
d. No.

### 5. I am a connoisseur

a. Strongly agree
b. Agree
c. Disagree
d. Strongly disagree

### 6. I'm a trend-setter

a. Stongly agree
b. Agree
c. Disagree
d. Strongly Disagree

### 7. You're 10 minutes late for work because you can't find the perfect shoes for your outfit.

a. You're frustrated, but throw on a 2nd option in the hopes no one will notice they don't match.
b. Shoes are far too trivial to make you late. You wouldn't be in this situation in the first place.
c. Scream and throw things around, regardless of whether you have an audience or are alone.

The sixth (and final) section of the test personality test relates to the “woodsy” family and probes whether the individual is likely to appreciate woodsy scents, based upon her personality. Some of the questions related to this family of scents may include:

### 1. I know exactly what I want to accomplish in life.

a. I strongly agree with this statement
b. I know what I want and will pursue my goals as long as it doesn't hurt those around me.
c. Pretty sure, but don't yet know how to get there.
d. I keep changing my mind. I'll decide someday.

### 2. When others are scratching their heads, I'm often the one who takes initiative to get the task done.

a. Strongly agree
b. Agree
c. Disagree
d. Strongly disagree

### 3. When invited to participate in a good cause, I:

a. Find a way to make a difference, however small.
b. Research it in depth to establish its validity. Once convinced, I'll do anything I can to help.
c. I donate to the office charity and that's enough.
d. Most charities just rip you off anyway.

### 4. Are you a judgmental person?

a. I have strong morals. I judge actions, not people.
b. I have a hard time accepting people who believe differently from me.
c. Ethical judgments are based upon the circumstance of the situation.
d. Live and let live.

### 5. Are you patient with long-term goals?

a. I have long-term goals with 5 &10 year plans.
b. I do an okay job of following through with goals.
c. My New Year's resolutions rarely last to February.
d. I don't want to cement my life. I live in the present.

### 6. I must be in touch with nature in order to be happy.

a. Stongly agree
b. Agree
c. Disagree
d. Strongly Disagree

### 7. People often turn to me for help because they recognize I am ethical, trustworthy, and wise.

a. Strongly agree
b. Agree
c. Disagree
d. Strongly disagree

Again, it is worth noting that the above-recited questions in the personality test are exemplary of the types of questions that may be used on the personality test. Other questions are clearly possible and within the scope of the present embodiments.

In some embodiments, the individual will take the personality test (in step 502 of the method 500 of FIG. 5) at a workshop or other social gathering designed to help the individual find their unique fragrance. Of course, the individual could complete the test prior to the workshop or during another setting.

Individuals take the personality test to determine their “fragrance personality.” The fragrance personality guides the individual to six fragrance families, each family containing scents that portray particular personality traits. The individual is given a unique, detailed fragrance personality profile indicating not only what their dominant fragrance family is, but providing an entire pie chart summing up their personality through scent. The possibility of two individuals receiving the exact same test results is very small.

Referring again to the method 500 of FIG. 5, once the individual has completed the personality test, the results of the personality test will be evaluated in step 504. Such evaluation may occur using the methods or embodiments disclosed above in conjunction with FIG. 3. This evaluation step 502 involves “scoring” the personality test to extract the person's fragrance profile.

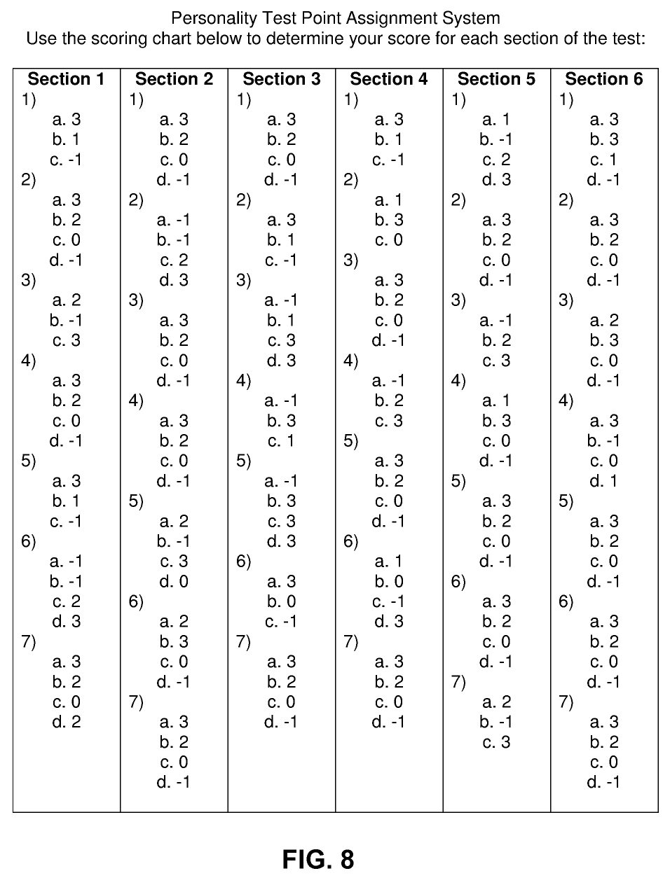

As explained above, each particular answer choice in the personality test is given a particular numerical value. Accordingly, evaluating the results of the test involves determining which answer was selected by the individual and finding the corresponding numerical value associated with selected choice. For the questions to the personality test listed above, FIG. 8 provides the listing of numerical values that may be assigned to each question:

The point values found in FIG. 8 are determined based on the individual's tendency to a fragrance personality family. The questions in the test are situational and the answers indicate how the individual would react in the given situation. Each fragrance family has a few “calling cards”, meaning if someone exhibits a certain behavior, the results of the test will more strongly identify them to a certain personality family. For instance, if someone is intellectual to the point of becoming a conspiracy theorist, this person would have a strong “Leafy” tendency or “calling card. There are also smaller indicators that point to someone belonging to a certain family. For instance, if someone enjoys fine arts, they could be a “Floral”, but they could also be dominant in another family. This is not a calling card for the Floral family, it's just a smaller indicator that could suggest the floral family. Following are the point values attainable and what each indicates:
0—A zero is assigned when the individual shows no tendency to the fragrance personality family at hand.
1—A one is assigned when the individual shows a very slight tendency to a calling card trait or a moderate resemblance to a smaller indicator.
2—A two is assigned when the individual shows a moderate tendency to a calling card trait or a strong tendency to a smaller indicator.
3—A three is assigned when the individual shows a strong tendency to a calling card trait or a very strong tendency to a smaller indicator.
−1—A negative one is assigned when the individual not only shows no tendency to the personality family, but also shows a tendency to a calling card or smaller indicator of a different family.

In the present example, if the individual selected answer choice “a” for the first question of Section 1, that answer is given a value of 3 points. If the individual selected answer choice “c” for the second question in Section 1, then the point value that is assigned is “0”. In this manner, the associated numerical values of the selected answers for a particular section of the test are determined using this table and are summed together. For convenience a space may be provided on the personality test to allow the individual to sum all of the numerical values associated with a particular section of the test. The summed total for each particular section may be referred to herein as the “net value.” This process will then be repeated for each section until all the sections have a total score.

In one example, the total score of each of the sections may be as follows:
Floral: 8
Fruity: 5
Herby: 6
Leafy: 4
Spicy: 5
Woodsy: 6

Using these numbers, the “grand total” may then be calculated. This grand total is made by summing all of the net values. In the above-recited example, the grand total would be 34, as shown in the following calculation.

Grand Total=Sum of all Net Values

8+5+6+4+5+6=34.

In order to make the personality test more accurate, so that each individual receives a unique personality profile, a pie chart may be created based on the scores. This way, the individual's full personality is revealed, instead of just sorting the individual into one of six categories. To accomplish this, each individual has a different “100%” score that may be calculated. This is derived by adding up each section total to receive a grand total and then using this grand total to find a percentage. Once the individual's 100% is determined, each section total is assigned a percentage instead of a score. This percentage is obtained by dividing the net value associated with a particular section by the grand total, as shown in the following calculations.
Floral Net Value: 8
Grand Total: 34

8÷34=0.235
Percentage Floral: 23.5%
Fruity Net Value: 5
Grand Total: 34

5÷34=0.147
Percentage Fruity: 14.7%
Herby Net Value: 6
Grand Total: 34

6÷34=0.176
Percentage Herby: 17.6%
Leafy Net Value: 4
Grand Total: 34

4÷34=0.117
Percentage Leafy: 11.7%
Spicy Net Value: 5
Grand Total: 34

5÷34=0.147
Percentage Spicy: 14.7%
Woodsy Net Value: 6
Grand Total: 34

6÷34=0.176
Percentage Woodsy: 17.6%

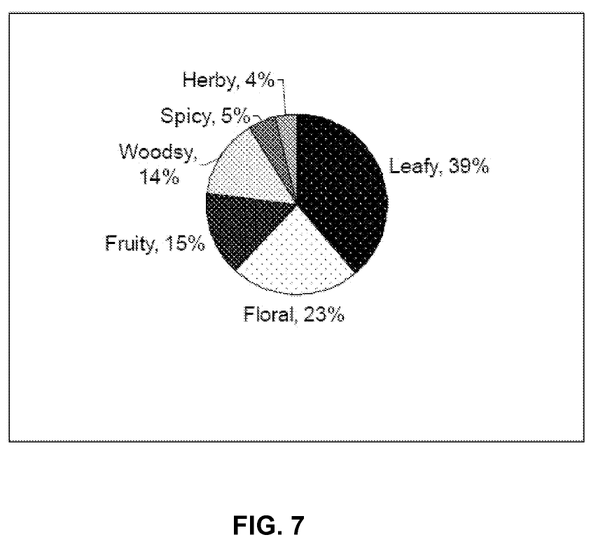

A “pie chart” may then be generated, representing the individual's personality profile. For instance, if an individual took a personality test and obtained the following personality profile: 39% Leafy, 23% Floral, 15% Fruity, 14% Woodsy, 5% Spicy, and 4% Herby, then based upon this breakdown, the pie chart for this individual would look as shown in FIG. 7.

Technically, with the individual profile outlined above, the “perfect” fragrance for this person would be one containing 39% Leafy scents, 23% Floral scents, 15% Fruity scents, and so forth, to perfectly reflect their personality. In some embodiments, the individual may choose to construct this “perfect” mixture that matches identically to the results of their profile. However the individual is allowed to take whatever creative liberties they wish and modify this “perfect” breakdown as desired. The test is used as a guideline and starting point for the individual.

Referring again to FIG. 5, after the results of the personality test have been evaluated, the next step in the method 500 involves using 506 the results of the test to determine which scent(s) and/or family(ies) of scents are appropriate for the individual. The sections of the personality test with the highest scores are the individual's dominant fragrance families. In other words, a fragrance containing scents from one's dominant fragrance family will represent the individual's personality more accurately than scents from other families.

The above individual (which had a distribution of 39% Leafy, 23% Floral, 15% Fruity, 14% Woodsy, 5% Spicy, and 4% Herby) will conclude that their dominant fragrance families are Leafy and Floral. These are the two families they will be guided to start searching in first, as people tend to prefer scents from the families they scored high in, over the other families. The above profiled individual may decide to add some fragrances from her secondary fragrance families Fruity and Woodsy scents and perhaps just a tiny bit of Spicy and Herby to their custom blend to perfectly portray their personality. However, the individual is free to limit their scent to only one or two families if they wish. The individual is also free only to use 3 families of scents, 4 families of scents, two (or more) scents from the same family, etc.

Based on their newly discovered personal fragrance profile, individuals will begin selecting scents 508 by probing/smelling scents from their preferred fragrance families identified by the Personality Test and write down their favorites from each family. Individuals are guided to choose at least two favorites so their blend is unique. In some embodiments, these two selected oils will be from the two dominant families of scents identified in the personality test. (In other embodiments, the two selected oils will be chosen based upon other factors). As the oils and fragrances are highly potent, this process of smelling/probing fragrances is to be done in a well ventilated area. The perfume oils are strong and it is recommended that the individual clear her olfactory palette by smelling coffee beans prior to beginning the process, as well other times during the process, as needed.

Once the individuals have probed the various scents, the individual is allowed, as part of the method 500, to mix 510 the scents to construct their own unique blend. There are some guideposts that the individual may follow during this mixing: first, they should create their recipe using one drop of perfume oil at a time into the provided mixing glass; second, the individual should smell their creation after adding each, single drop; and third, the individual should take care to write down each and every drop that is added to their blend.

During this mixing process, each individual is given a mixing glass (or other receptacle) and they are instructed to choose two favorites from the scents they wrote down as they were probing the scents. The individual then adds one drop of each of these two scents to their mixing glass, and writes the first two drops down a sheet of paper. As part of the method 500, the individual may then determine 512 if modifications to their mixture is desired. The individual will then be asked to smell their blend in progress contained in their mixing glass. The individual will then be required to ask themselves the following questions (or similar questions) regarding their new fragrance blend:
1. Do I like it?
2. Do I want one of my two scents to be stronger or lighter than the other?
3. Do I want my fragrance to be more sweet/bitter/fresh/citrus/fruity/floral/spicy/deep/hearty/light/airy/warm/cool/or have some other characteristic?
4. Do I want to introduce an additional scent (i.e., a third scent, a fourth scent, a fifth scent, a sixth scent, etc.)?

Once the individual has answered these questions for herself, she will then be provided the solution to the answers.

If the answer to question 1 is “no”, the individual may chose to start the mixing process over or continue.

If the answer to question 1 is “yes” they continue.

If the answer to question 2 is “yes,” the client can accomplish what they want by adding a second drop of one or the other scent. They will continue this until the balance they want is achieved.

If the answer to question 2 is “no” they continue to question 3.

If the answer to question 3 is “no” they continue to question 4.

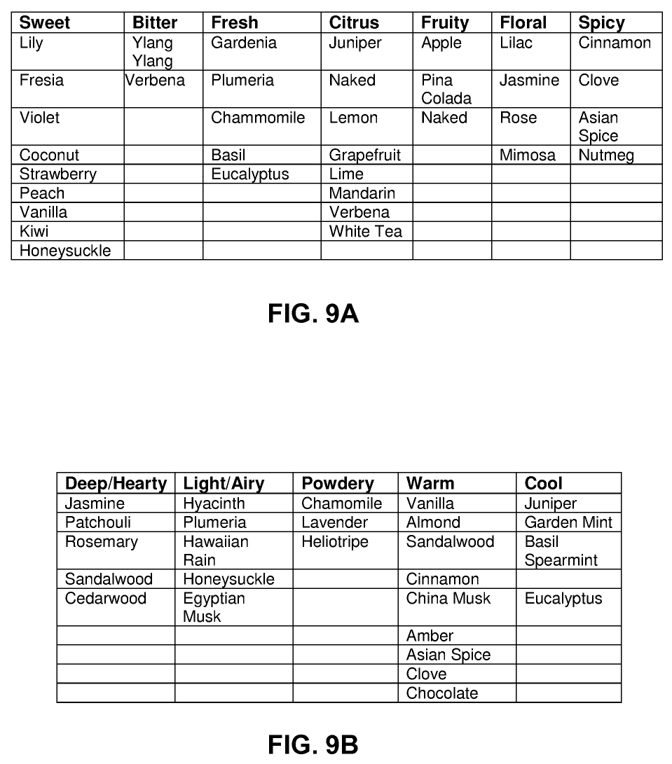

If the answer to question 3 is “yes,” the individual can accomplish what they want by adding a second drop of one or the other scent, or by introducing a third scent that contains the properties they are looking for (i.e.: sweet, fresh, citrus, etc). This can be accomplished by having the individual add a scent that they identified above as being one of their favorites. Other embodiments may be made in which the individual is provided a list of scents that can help them achieve each “type” of scent they are looking for or that will have the desired effect. An example of this type of list is found in FIGS. 9a and 9b. In some embodiments, the list found in FIGS. 9a and 9b will be combined together; however, in other embodiments, the lists of FIGS. 9a and 9b will be used separately.

Thus, based upon the list of FIGS. 9a and 9b, if the individual wants to make the fragrance blend more “bitter,” she will add either Ylang Ylang or Verbena. If the individual wants to make the blend more “warm,” she may add vanilla, almond, sandalwood, cinnamon, china musk, amber, asian spice, clove, or chocolate. Other additions are based upon the table. The amount of each additive will depend upon the individual's preferences and may be tested. Of course, the chart provided above is only a partial list of scents or agents that may be used to modify the fragrance or provide a “property” that the individual desires. Other possible additives or agents are clearly possible and within the scope of the present embodiments.

The individual will then ask themselves question number 4 in the above-recited list. If the answer to question 4 is “yes,” the individual will go back to their list of favorite scents and analyze which scent(s) or family(ies) of scents they feel will compliment their current fragrance recipe. If the answer to question 4 is “no”, they continue with the mixing process and repeat this mixing/testing process as necessary.

It should be noted that the individual will ask herself the above questions after adding each single drop to her recipe. During this time, a representative or “Scent Consultant” (which is sometimes referred to as a “Fragrance Designer”) may be provided to answer questions and provide suggestions to help the individual reach a recipe they find accept.

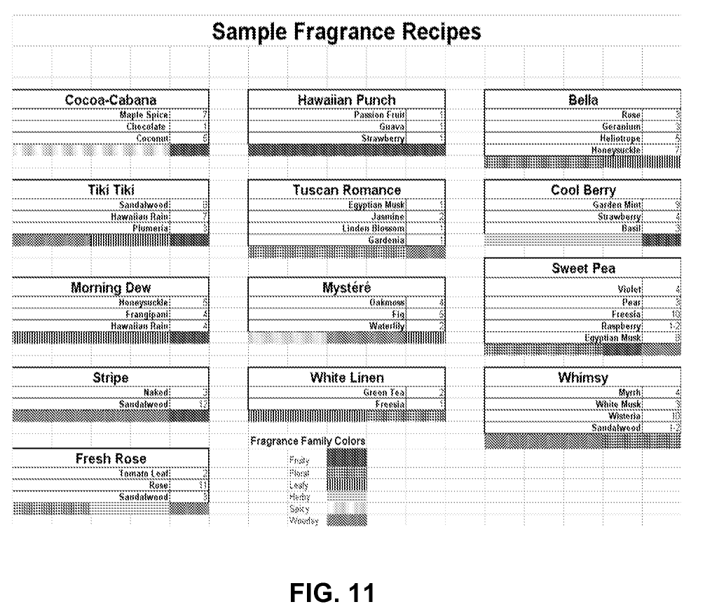

If the individual fails, after repeated attempts to create a desired fragrance, they can be provided with a “pre-blended” mixture that contains a variety of commonly preferred scents. These “pre-blended” mixtures can provide the individual with a “starting point”, which would allow the individual to then make modifications (by adding drops, etc.) in accordance with their own preferences. Some examples of common “pre-blended” mixtures are shown in FIG. 11. These common “pre-blended” mixtures relate to all of the different families of scents.

Once the individual has finished steps of mixing 510 the scents and making the appropriate modifications 512, they have created the base blend of their unique scent and they continue to step 514. The duplication formula may be necessary if the total number of total drops in the base blend is less that the concentration required to mix her unique scent with the selected health and beauty or other product. If the individual determines that this step of determining the formula necessary to duplicate is not necessary, the individual will simply move onto the step, if desired, of mixing 516 the unique scent with one or more unscented health and beauty products.

In order to determine 514 the formula necessary to duplicate the unique scent, the individual may use a worksheet. In some embodiments, this worksheet is referred to as the “My Scent In Progress” worksheet.

The worksheet may include a process that will guide the individual through a process of determining the formula necessary to duplicate the individual's unique scent. The worksheet may include a chart (or other listing) in which the individual records the exact number of drops needed to create her signature blend—i.e., 5 drops of “A” scent, 2 drops of “B” scent, 1 drop of “C” scent, etc. The total number of drops is then added up to get a total drop count. In this example, the total drop count would be “8” (because 5+2+1=8).

The worksheet will then provide the individual with the number of drops that are necessary in the final health and beauty product. Although these amounts may change depending upon the embodiment, it is presently known that, in order to construct a perfume, the total number of drops in the perfume bottle should be about 150. Likewise, in order to mix this custom-blended scent with lotion, shower gel, bubble bath, shampoo, etc., it is presently believed that about 50 drops should be in the final mixture. Of course, these numbers of total drops in the health and beauty product are but examples. These amounts may change depending upon the size and other properties of the health and beauty product, the concentration of scent desired, etc.

Once the individual has identified the number of drops necessary in the final product, the user may use the following formula to determine the scaling factor (which is sometimes referred to as the “X Factor”):

(Y÷Z)−1=X FACTOR
Z=Number of total drops in individual's unique scents base blend
Y=Number of drops needed to mix with unscented product (which is obtained from the worksheet).

Once the individual has determined the X Factor, this factor may then be multiplied by the number of drops of each particular ingredient to scale the unique scent for each health and beauty product.

For purposes of clarity, an example will be given of the scaling process. If an individual had a blend consisting of 5 drops of “A” scent, 2 drops of “B” scent, 1 drop of “C” scent, then the total number of drops in this blend is 8. This is the letter “Z” in the above-recited formula.

If the individual wanted to make body lotion that had this unique scent, then the number of drops needed to mix with unscented body lotion, as provided on the worksheet, is 50. This number represents the letter “Y” in the above-recited formula.

Accordingly, plugging the numbers into the formula reveals the following X Factor:

(50÷8)−1=5.25=X FACTOR

This X factor (scaling factor) is then used to scale the number of drops associated with each individual component:
5 drops of “A” scent multiplied by the X factor:

5×5.25=26.25 drops of “A” scent
2 drops of “B” scent multiplied by the X factor:

2×5.25=10.5 drops of “B” scent
1 drop of “C” scent multiplied by the X factor:

1×5.25=5.25 drops of “C” scent

Thus, using this formula, the user rounds the number of drops to add to the nearest integer and then would mix 26 drops of scent “A”, 11 drops of scent “B” and 5 drops of scent “C” in a container. Once this mixture has been obtained, the individual may mix (in step 516) this amount of the unique blend with the unscented lotion to obtain the new, scented lotion that contains the individual's unique fragrance.

Of course, once the individual finishes duplicating the amount of the product necessary for the lotion, the individual may repeat this process as desired, to make other scented health and beauty products. Each different health and beauty product may have a different calculation, depending upon the numbers provided on the worksheet.

It should be noted that in order to transfer the individuals' signature scent to the unscented heath and beauty products, the user may need to use a disposable transfer pipette dropper to introduce the mixture into the unscented health and beauty product. A mixing stick may then be used to distribute the signature, unique scent throughout the product. In other embodiments, the individual may simply shake the product to distribute the scent. In general, the oils and fragrances used to make the unique scent will be designed such that they diffuse completely into the product over the course of a few hours. This means the fragrance and the product will be thoroughly mixed after a few hours, even if the individual was not able to do so with the mixing stick, shaking, or other mixing processes.

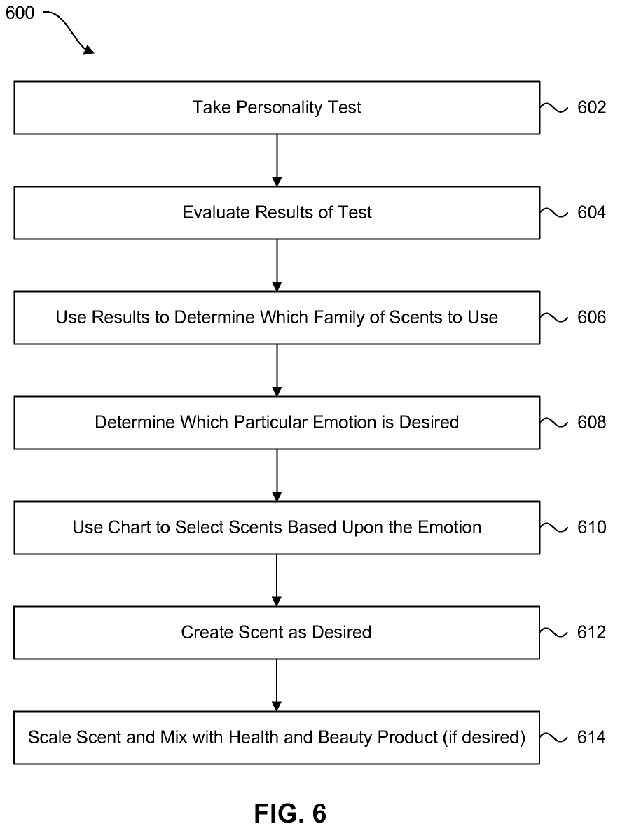

Referring now to FIG. 6, another embodiment of a method for determining a unique scent for an individual is disclosed. The method 600 is similar to the method 500 disclosed above in conjunction with FIG. 5. In fact, the first three steps of the method 600, namely the “take the personality test” step 602, the “evaluate the results of the personality test” step 604, and the “use the results to determine which family of scents to use” step 606 may be similar and/or identical to the corresponding steps 502, 504, and 506 disclosed above in the method 500 of FIG. 5. Accordingly, the reader should consult the above-recited disclosure for a description of these steps.

As noted above, sometimes an individual desires to portray an emotion, feeling, attitude, etc. as part of their fragrance. (Collectively, these emotions, feelings, attitudes, etc. will be referred to herein as a “particular emotion”). For example, an individual may want to have their scent portray the particular feeling of being “energetic.” On other occasions, the individual may want to portray or project the feeling of being “confident” or “motivated.” These specialized scents may be appropriate for special scent for a special occasion (such as a birthday, anniversary, special social gathering, special date, awards banquet, etc.).

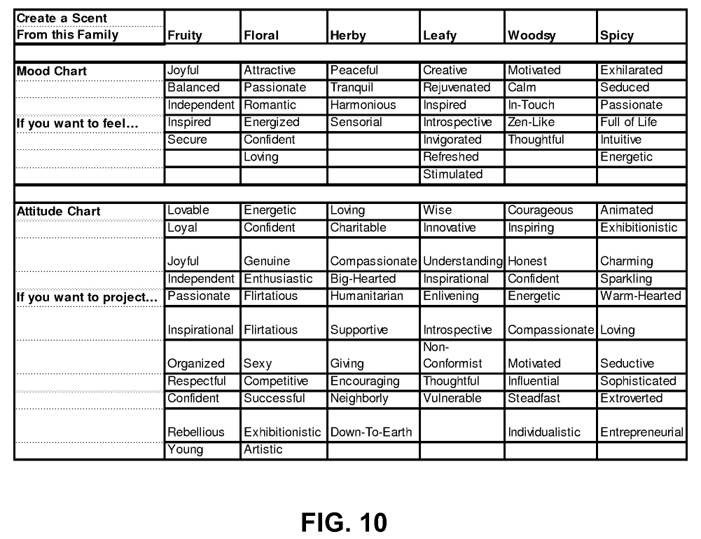

Accordingly, as part of the method 600, the individual will determine 608 which particular emotion she decides she wants to feel or portray. The individual will then use 610 a chart (shown in FIG. 10) to select scents based upon a particular emotion that is selected. A sample chart (FIG. 10) that deals with the particular emotion is included herein:

It should be noted that the above-recited chart in FIG. 10 is but one example of the various types of “particular emotions” that are possible. Other emotions, feelings, etc. may be possible and may be classified in these or other families of scents.

Once the individual has determined which particular emotion is desired, the chart will immediately convey information to the individual regarding which family (or families) of scents correspond to this particular emotion. The individual may already know, from her previous probing of the scents, which oils/fragrances from a particular family of scents are her favorites. For example, if the individual wants to feel “giving”, she may simply select one of her favorite scents from the “herby” family. If the individual wants to feel “creative”, she will select a fragrance from the “leafy” family, etc. Accordingly, she can simply select one of these desired fragrances (from the relevant family) that correspond to her particular emotion and is sufficiently pleasing to her sense of smell. (Of course, if the individual has not already selected her favorite scents from each particular family, such selection may occur, in the manner described above).

Once the individual has found a scent that corresponds to a particular feeling/emotion, the individual may then create 612 the desired scent. (The manner of creating this scent, which occurs by mixing scents/oils, has been described above.) In some embodiments, this creating of the scent 612 may involve mixing new scents together; in other embodiments, the individual may simply modify an existing scent that was created on a previous occasion or was a “pre-blended” mixture. The individual may then test the new scent, modify the new scent, add further scents, etc. In some embodiments, the individual may also, as shown in step 614, scale the scent and mix the scent with a health and beauty product (in the manner described above).

As noted above, some embodiments may be designed in which a representative 130 (shown in FIG. 1) may assist the individuals 116 (shown in FIG. 1) in creating their own unique, personalized fragrance. This representative 130 may be a “Fragrance Designer” or “Scent Consultant” that has knowledge regarding the various scents and is capable of assisting the individuals 116 is constructing their own personalized scents.

For example, in some embodiments, the representative 130 will own the kit 110 (shown in FIG. 1) and will bring the kit 110 to a party or workshop. At this workshop, the representative 130 may administer the personality test and/or may assist the individuals 116 in evaluating the results of the personality test. Once the individuals have taken and evaluated the test results, the representative 130 may assist the individuals 116 in mixing the various perfume oils 120, provide suggestions or guidance as to which of the oils 120 are desirable, pleasant, fit with the individualized results of the personality test, etc. The representative 130 may also provide guidance on how much of the oils 120 may be used and/or how much of the mixed scent should be used when this scent is mixed with the health and beauty product 122. Further embodiments may be designed in which the representative provides guidance regarding how to scale the scent recipe for mixing with other products. The representative 130 may also provide guidance, by looking at lists or charts, on how the individual may modify her scent to portray a specific emotion or feeling. Thus, by providing a representative 130, the individual 116 may have someone to help her during the process of creating her own unique scent.

Further, in some embodiments, the individual 116 is directly involved in constructing the individualized scent that is unique to her. In other words, the individual 116 may select the scents that are desirable, mix the scent in the proportions she chooses, etc. By having the individual 116 directly involved in constructing her own scent, favorable results may be obtained.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. A method for determining a unique scent for an individual, the method comprising:
administering a personality test;
evaluating results of the personality test to determine one or more characteristics of the individual's personality;
providing one or more families of scents that correspond to the characteristics of the individual's personality; and
determining an individualized scent from the results of the personality test and the families of scents.

2. A method as in claim 1 wherein the results are evaluated at a workshop that helps the individual understand the test results.

3. A method as in claim 1 further comprising the step of constructing a personality test that probes various characteristics of the individual's personality.

4. A method as in claim 1 further comprising the step of selecting scents from the families of scents.

5. A method as in claim 4, wherein the step of selecting scents includes having the individual probe scents from the family to determine which scents fit that person's olfactory and/or emotional preferences.

6. A method as in claim 1 wherein the families of scents is selected from the group consisting of floral, fruity, herby, leafy, spicy, and woodsy, and wherein an individual may select one or more scents from any of the families of scents.

7. A method as in claim 1, wherein the personality test comprises a series of multiple-choice questions that are associated with each particular family of scents, and wherein the evaluating step comprises:
assigning a numerical value to each possible answer for each multiple choice question;
determining the answer to each multiple choice question selected by the individual;
verifying the numerical value of the selected answers; and
summing the numerical values associated with the selected answers.

8. A method as in claim 7, further comprising the step of dividing the summed value of the numerical values associated with the selected answers by a grand total.

9. A method as in claim 7, further comprising the steps of:
selecting scents from the families of scents;
constructing an individualized scent from the selected scents; and
mixing the individualized scent with a health and beauty product;

10. A method as in claim 1 further comprising the step of providing a chart or other reference guide to the individual which links a particular emotion to a scent or family of scents.

11. A method as in claim 1 further comprising the step of determining the formula necessary to duplicate the individualized scent.

12. A method as in claim 1 further comprising the step of constructing the individualized scent.

13. A method as in claim 12 further comprising the step of mixing the individualized scent with a health and beauty product.

14. A kit for preparing a unique scent for an individual, the kit comprising:
a personality test that probes various characteristics of an individual's personality;
one or more families of scents that correspond to a characteristic of the individual's personality; and
a health and beauty product, wherein an individualized scent from results of the personality test and the families of scents may be mixed with the health and beauty product.

15. A kit as in claim 14 wherein the health and beauty product is selected from the group consisting of lotions, perfumes, and shower products.

16. A kit as in claim 14 wherein the personality test comprises a series of multiple-choice questions that are associated with each particular family of scents, wherein the kit further comprises an answer key that assigns a numerical value to each possible answer for each multiple choice question.

17. A kit as in claim 14 wherein one or more of the families of scents is selected from the group consisting of floral; fruity, herby, leafy, spicy, and woodsy.

18. A kit as in claim 14, wherein the kit further comprises a chart which links a particular emotion to a scent or family of scents.

19. A method for determining a unique scent for an individual, the method comprising:
administering a personality test;
evaluating results of the personality test to determine one or more characteristics of the individual's personality;
providing one or more families of scents that correspond to the characteristic of the individual's personality;
determining what particular feeling the individual desires;
determining which family of scents is associated with the particular feeling; and
determining the individualized scent from the results of the personality test, the particular feeling desired by the individual, and the families of scents.

20. A method as in claim 19, wherein a chart is provided which allows the individual to determine which family of scents is associated with the particular feeling with a scent.

21. A method for determining a unique scent for an individual, the method comprising:
conducting a workshop with at least one individual and a scent consultant;
providing one or more families of scents, wherein the families of scents each comprise a plurality of scents; and
selecting scents that fit with the individual's preferences, wherein the scents are selected at the workshop with suggestions from the scent consultant;
mixing the selected scents to form a scent that is unique to the individual.

22. A method as in claim 21 wherein the individual selects the scents by probing scents from the families of scents and wherein the method further comprises the step of mixing the individualized scent with a health and beauty product.

23. A method as in claim 21 further comprising:
administering a personality test;
evaluating results of the personality test to determine one or more characteristics of the individual's personality, wherein the results of the personality test are used to select the scents and wherein the results are evaluated at the workshop.
